(19) United States
(12) Patent Application Publication
(10) Pub. No.: US 2016/0353395 A1
(43) Pub. Date: Dec. 1, 2016

(54) WIRELESS COMMUNICATION APPARATUS AND COMMUNICATION METHOD

(71) Applicant: Mitsubishi Electric Corporation, Tokyo (JP)

(72) Inventors: Toshio KAWAGISHI, Tokyo (JP); Jun KATADA, Tokyo (JP); Shingo HIGUCHI, Tokyo (JP)

(73) Assignee: Mitsubishi Electric Corporation, Tokyo (JP)

(21) Appl. No.: 15/117,325

(22) PCT Filed: May 22, 2014
(86) PCT No.: PCT/JP2014/063549

§ 371 Date: Aug. 8, 2016

(51) Int. Cl. H04W 56/00; H04W 76/02; H04L 29/08

(52) U.S. Cl. CPC H04W 56/00; H04L 67/303; H04W 56/0015; H04W 76/023; H04W 84/20

(57) ABSTRACT

The present invention has an object to provide a technique capable of appropriate communications with various communication terminals. An on-board device includes a communication unit and a controller. The communication unit is capable of communication with a communication terminal using a plurality of profiles including an HFP and an AVP while assuming the role of a master. The controller inhibits a switch of the role of the communication unit from a master to a slave when no extended synchronization packet is included in packet information transmitted to the communication unit from the communication terminal communicating with the communication unit using the HFP.

### TECHNICAL FIELD

The present invention relates to a wireless communication system for communications such as Bluetooth (registered trademark) communication and a communication method for wireless communication.

### BACKGROUND ART

In Bluetooth communication, a communication device and a communication terminal (e.g., a mobile phone or smartphone) each assume the role of a master or a slave to provide a connection state called piconet. The piconet has a scheme in which the communication with a slave is established in accordance with the communication timing determined by a master, where a communication timing of one piconet is not synchronized with that of another piconet. Also in Bluetooth communication, a connection state called scatternet may be provided in which one communication device operates as a slave in one piconet while operating as a master in another piconet or operates as slaves of a plurality of piconets. In such a connection state, communication timings of the respective piconets cannot be synchronized with each other.

As a problem occurring in such an asynchronization case, for example, if a communication device assumes the role of a master to communicate with a communication terminal using a hands free profile (HFP) for hands free calling and also assumes the role of a slave to communicate with another communication terminal using an AVP (a generic name for audio-related profile) for outputting voice such as music, a connection state of a scatternet is provided. Depending on each status of communication, consequently, the quality of a voice output using the AVP may degrade or communication itself may be disconnected.

Known on-board devices such as a navigation device perform Bluetooth communication with a communication terminal (e.g., see Patent Document 1). To prevent, for example, AVP communication from being disconnected due to the above-mentioned phenomenon, a conventional on-board device controls its communication so as to provide a connection state of a piconet in which the on-board device assumes the role of a master for a plurality of communication terminals. Specifically, the on-board device is configured to reject a request for a role switch to switch from a master to a slave if a communication terminal makes the request to the on-board device.

### PRIOR ART DOCUMENT

### Patent Document

Patent Document 1: Japanese Patent Application Laid-Open No. 2010-79423

### SUMMARY OF INVENTION

### Problem to be Solved by the Invention

Unfortunately, some communication terminals on the market are based on the premise that the communication terminal operates as a master.

The on-board device is configured to reject a request for a role switch as described above, and accordingly, a communication connection with the on-board device may fail depending on how the communication terminal whose request for a role switch has been rejected is installed. Or, even when a communication connection with the on-board device succeeds in a lower-order protocol, a communication connection with the on-board device fails in a higher-order protocol, thus limiting some type of service function in data communication and network communication. As a result, the convenience of users may be lost. Moreover, communication terminals that accommodate only the role of a master are being appearing in the market, and on-board devices may fail to appropriately communicate with such communication terminals, as described above.

The present invention therefore has been made in view of the problems above and has an object to provide a technique capable of appropriate communications with various communication terminals.

### Means to Solve the Problem

A wireless communication system according to the present invention includes a communication unit and a controller. The communication unit communicates with a communication terminal using a plurality of profiles including a first profile related to hands free calling and a second profile related to audio. The controller inhibits a switch of a role of the communication unit from a master to a slave when no extended synchronization packet is included in packet information transmitted to the communication unit from the communication terminal communicating with the communication unit.

A wireless communication system according to the present invention includes a communication unit and a controller. The communication unit communicates with a communication terminal using a plurality of profiles including a first profile related to hands free calling and a second profile related to audio. The controller inhibits a switch of a role of the communication unit from a master to a slave when the communication unit communicates with a plurality of the communication terminals using both of the first and second profiles.

A communication method according to the present invention causes a communication unit to communicate with a communication terminal using a plurality of profiles including a first profile related to hands free calling and a second profile related to audio, and inhibits a switch of a role of the communication unit from a master to a slave when no extended synchronization packet is included in packet information transmitted to the communication unit from the communication terminal communicating with the communication unit.

### Effects of the Invention

The present invention prevents the conventional problems and enables appropriate communication with a communication terminal that assumes only the role of a master.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram for explaining the basics of Bluetooth communication.

FIG. 2 is a diagram for explaining the basics of Bluetooth communication.

FIG. 3 is a diagram for explaining the basics of Bluetooth communication.

FIG. 4 is a diagram for explaining the basics of Bluetooth communication.

FIG. 5 is a block diagram illustrating the configuration of an on-board device according to a first embodiment.

FIG. 6 is a diagram for explaining the operation of the on-board device according to the first embodiment.

FIG. 7 is a block diagram illustrating the configuration of the on-board device according to the first embodiment.

FIG. 8 is a flowchart illustrating the operation of the on-board device according to the first embodiment.

FIG. 9 is a sequence diagram illustrating the operation of the on-board device according to the first embodiment.

FIG. 10 is a sequence diagram illustrating the operation of the on-board device according to the first embodiment.

FIG. 11 is a sequence diagram illustrating the operation of the on-board device according to the first embodiment.

FIG. 12 is a sequence diagram illustrating the operation of an on-board device according to a second embodiment.

FIG. 13 is a sequence diagram illustrating the operation of the on-board device according to the second embodiment.

FIG. 14 is a sequence diagram illustrating the operation of an on-board device according to a third embodiment.

FIG. 15 is a sequence diagram illustrating the operation of an on-board device according to a fourth embodiment.

FIG. 16 is a flowchart illustrating the operation of an on-board device according to a fifth embodiment.

FIG. 17 is a sequence diagram illustrating the operation of the on-board device according to the fifth embodiment.

FIG. 18 is a sequence diagram illustrating the operation of the on-board device according to the fifth embodiment.

FIG. 19 is a sequence diagram illustrating the operation of the on-board device according to the fifth embodiment.

FIG. 20 is a diagram for explaining the operation of an on-board device according to a sixth embodiment.

FIG. 21 is a diagram for explaining the operation of the on-board device according to the sixth embodiment.

FIG. 22 is a flowchart illustrating the operation of an on-board device according to a seventh embodiment.

FIG. 23 is a sequence diagram illustrating the operation of the on-board device according to the seventh embodiment.

FIG. 24 is a sequence diagram illustrating the operation of the on-board device according to the seventh embodiment.

FIG. 25 is a sequence diagram illustrating the operation of the on-board device according to the seventh embodiment.

FIG. 26 is a sequence diagram illustrating the operation of the on-board device according to the seventh embodiment.

FIG. 27 is a block diagram illustrating the configuration of a communication terminal according to a modification.

### DESCRIPTION OF EMBODIMENTS

### First Embodiment

Embodiments below will describe, as an example, a case in which a wireless communication system according to the present invention is implemented in a single on-board device (e.g., head unit) with a combination of a navigation function, a calling function, and an AV function. The on-board device is configured to perform Bluetooth communication with communication terminals such as mobile phones and smartphones.

The following will describe the basics of Bluetooth communication and an on-board device (hereinafter, referred to as a “related on-board device”) related to an on-board device according to a first embodiment of the present invention before describing the on-board device according to the first embodiment.

<Basics>

<Profiles>

FIGS. 1 to 3 illustrate a state in which a communication device 81 performs Bluetooth communication with a communication terminal 2 such as a mobile phone or a smartphone. In Bluetooth communication, profiles for the communication device 81, the communication terminal 2, and the like to execute various functions are defined.

FIG. 1 illustrates a state in which the communication device 81 is in communication connection with the communication terminal 2 using a profile for performing data communication with a network, such as a personal area network profile (PAN). In the communication using the PAN, the communication device 81 can communicate with a base station 3 via the communication terminal 2 or communicate with a server 5 or a base station 6 via the communication terminal 2, the base station 3, and a communication network 4.

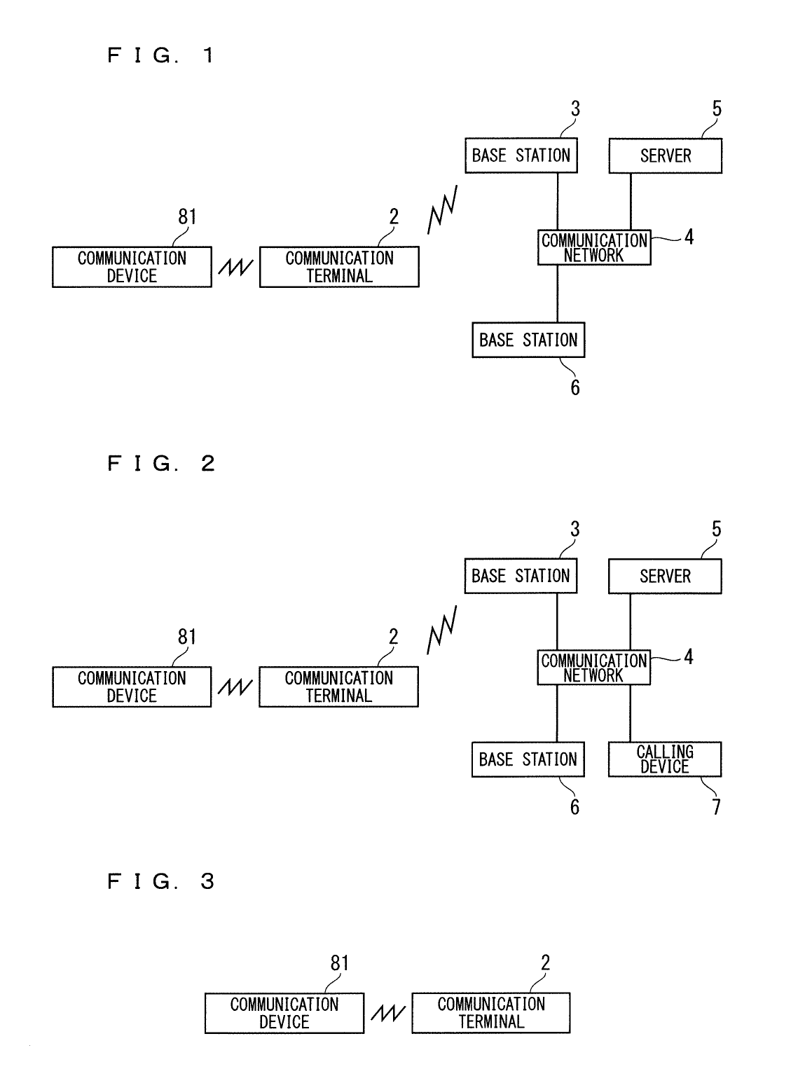

FIG. 2 illustrates a state in which the communication device 81 is in communication connection with the communication terminal 2 using a profile called HFP. In the communication using the HFP, the user of the communication device 81 can have a telephone conversation with a calling device 7 that is a calling party via the communication terminal 2, the base station 3, and the communication network 4.

FIG. 3 illustrates a state in which the communication device 81 is in communication connection with the communication terminal 2 using a profile called AVP. In the communication using the AVP, the communication device 81 can receive voice data such as music transmitted from the communication terminal 2 and output a voice corresponding to the voice data.

In the Bluetooth communication profile, additionally, various profiles such as a fax profile (FAX) for facsimile transmission and a file transfer profile (FTP) for file transfer are defined.

<Master, Slave, Piconet>

In Bluetooth communication between the communication device 81 and the communication terminal 2, one of the communication device 81 and the communication terminal 2 assumes the role of a master, and the other assumes the role of a slave.

For example, when a communication device 81 assumes the role of a master and a plurality of communication terminals 2 each assume the role of a slave, a network (piconet) that unifies the plurality of communication terminals 2 that are slaves is formed around the communication device 81 that is a master. Meanwhile, for example, when a communication terminal 2 assumes the role of a master and a communication device 81 and another communication terminal 2 each assume the role of a slave, a network (piconet) that unifies the communication device 81 and the other communication terminal 2 that are slaves is formed around the communication terminal 2 that is a master.

In this manner, one or a plurality of piconets are formed for one master. The communication timing of each piconet is determined by the master.

<Scatternet Connection, SCO Link>

The communication device 81 and the communication terminal 2 each can be connected to a plurality of piconets. For example, the communication device 81 can belong to one piconet while belonging to another piconet. Such a connection is called scatternet connection.

When the communication device 81 is in scatternet connection, the communication device 81 can assume the role of a slave in one piconet while assuming the role of a master in another piconet. Besides, the communication device 81 can assume the role of a slave in one piconet while assuming the role of a slave in another piconet.

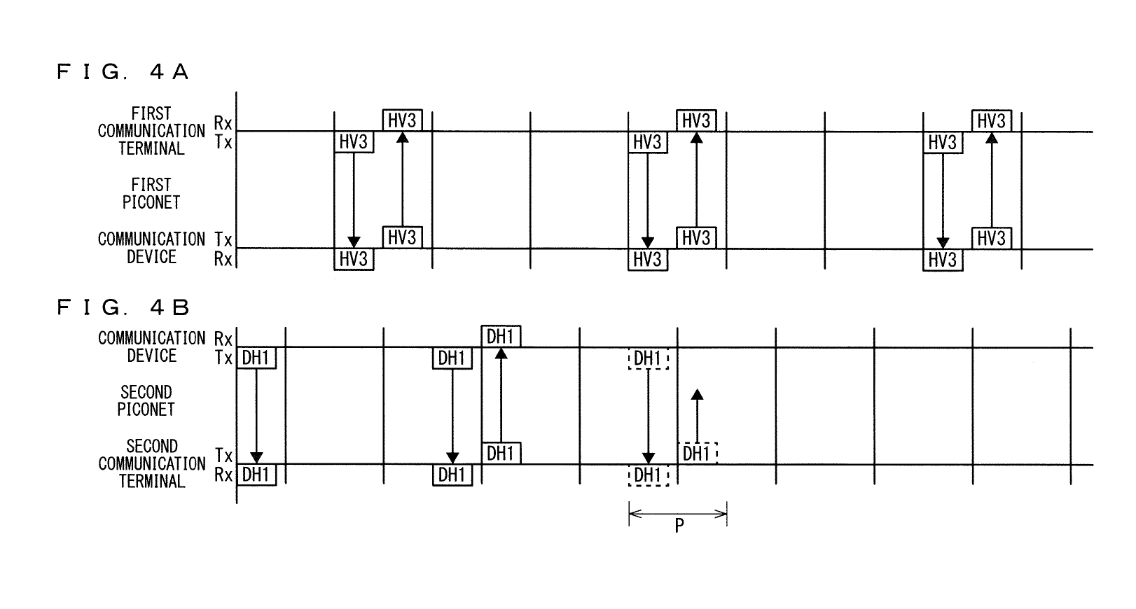

The following will describe a synchronization timing in communication through a scatternet connection. FIGS. 4(a) and 4(b) illustrate an example synchronization timing in the communication through a scatternet connection.

Specifically, with reference to FIG. 4(a), the communication device 81 assumes the role of a slave in a first piconet formed by the communication device 81 and a first communication terminal, and with reference to FIG. 4(b), the communication device 81 assumes the role of a master in a second piconet formed by the communication device 81 and a second communication terminal. Besides, with reference to FIG. 4(a), the communication device 81 communicates with the first communication terminal using the HFP, and with reference to FIG. 4(b), the communication device 81 communicates with the second communication terminal using the AVP.

As illustrated in FIG. 4(a), in the communication using the HFP, a packet switching connection by a point-to-point link called synchronous connection oriented (SCO) link is performed every certain period (e.g., every six slots). In other words, packets are repeatedly transmitted and received periodically in the SCO link.

As illustrated in FIG. 4(b), in the communication using the AVP, packets related to asynchronous connection-less (ACL) are repeatedly transmitted and received aperiodically.

As described above, the communication timing of the first piconet is controlled by the first communication terminal that assumes the role of a master, and the synchronization timing of the second piconet is controlled by the communication device 81 that assumes the role of a master. Thus, the communication timings between the first piconet and the second piconet have no dependence and are asynchronous with each other.

Consequently, the communication operation (reception) of the communication device 81 during a period P of the first piconet in FIG. 4(a) may collide with the communication operation (transmission) of the communication device 81 during the period P of the second piconet in FIG. 4(b), so that the communication operation of the communication device 81 of FIG. 4(b) will not be performed. If the profile used is a profile that needs real-time performance, such as the AVP for voice output, the collision is conspicuous as a failure, where a voice output may be disconnected, or in the worst case, communication itself may be disconnected.

<Role Switch>

To resolve such a failure associated with the asynchronization between the piconets, the communication device 81 can assume the role of a master in both of the first piconet and the second piconet without performing a scatternet connection. Specifically, in the first piconet, the communication device 81 that is a slave can request the first communication terminal that is a master to switch to a slave so that the first communication terminal switches from a master to a slave and that the communication device 81 switches from a slave to a master in the relationship with the first communication terminal. Such a switch between roles is called a role switch.

The role switch may be made appropriately in accordance with, for example, the type of a profile used in communication. For example, when the communication terminal 2 begins to perform a communication connection with the communication device 81 using the PAN while the communication device 81 is assuming the role of a master, the communication terminal 2 may request the communication device 81 to perform a role switch to switch from a master to a slave. The execution of a role switch usually changes the topology of a communication network.

<Related on-Board Device>

The following will describe an on-board device related to the on-board device according to the first embodiment, that is, a related on-board device.

The related on-board device is compatible with the communication device 81 described above, and is configured to perform Bluetooth communication with the communication terminal 2. When the related on-board device communicates with a communication terminal 2 using the HFP through a scatternet connection and communicates with another communication terminal 2 using the AVP, as described above, a voice output by the AVP may be disconnected.

The related on-board device is thus configured to, even when the communication terminal 2 requests the related on-board device to make a request for a role switch to switch from a master to a slave, reject such a request so as to assume the role of a master for a plurality of communication terminals 2.

When the communication terminal 2 begins to perform a communication connection using the PAN that may request the related on-board device to assume the role of a slave, however, the communication terminal 2 may fail to appropriately communicate with the on-board device using the PAN because the related on-board device is configured to reject a request for a role switch from the communication terminal 2 or the like. Besides, communication terminals 2 that assume only the role of a master are appearing in the market, and thus, the related on-board device may fail to appropriately communicate with the communication terminals 2, similarly to the above.

<Configuration of on-Board Device According to First Embodiment>

An on-board device according to the first embodiment described below, in contrast, can solve the problems described above.

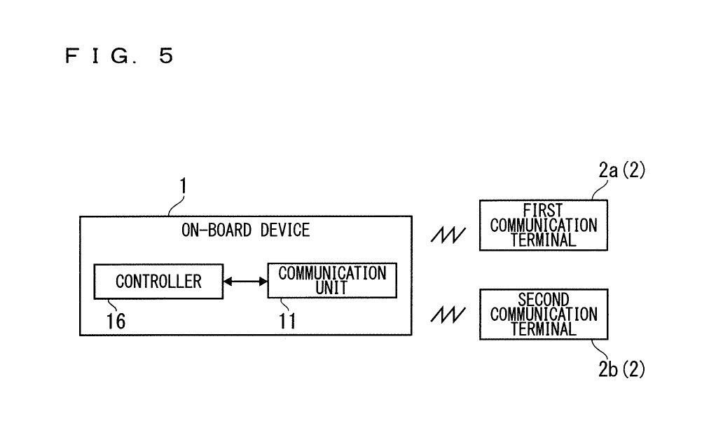

FIG. 5 is a block diagram illustrating a main configuration of an on-board device 1 according to the first embodiment. The on-board device 1 of FIG. 5 includes a communication unit 11 and a controller 16 that controls the communication unit 11. The on-board device 1 can perform Bluetooth communication with a communication terminal 2. Although FIG. 5 illustrates an example in which the on-board device 1 performs Bluetooth communication with two communication terminals 2 (a first communication terminal 2a and a second communication terminal 2b), the number of communication terminals 2 that perform this communication with the on-board device 1 is not limited to this number.

The communication unit 11 can assume the role of a master to communicate with the communication terminal 2 using a plurality of profiles including the HFP (first profile) related to hands free calling and the AVP (second profile) related to audio. The communication unit 11 is mainly composed of a wireless communication device according to the Bluetooth standard.

The controller 16 is implemented as the function of a central processing unit (CPU, not shown) of the on-board device 1 by, for example, the CPU or the like executing a program stored in a memory (not shown) such as a semiconductor memory of the on-board device 1. The execution of the program implements the controller 16 with various functions. As one of the functions, the controller 16 inhibits a switch of the role of the communication unit 11 from a master to a slave when no extended synchronization packet is included in the packet information transmitted to the communication unit 11 from the communication terminal 2 communicating with the communication unit 11 using the HFP.

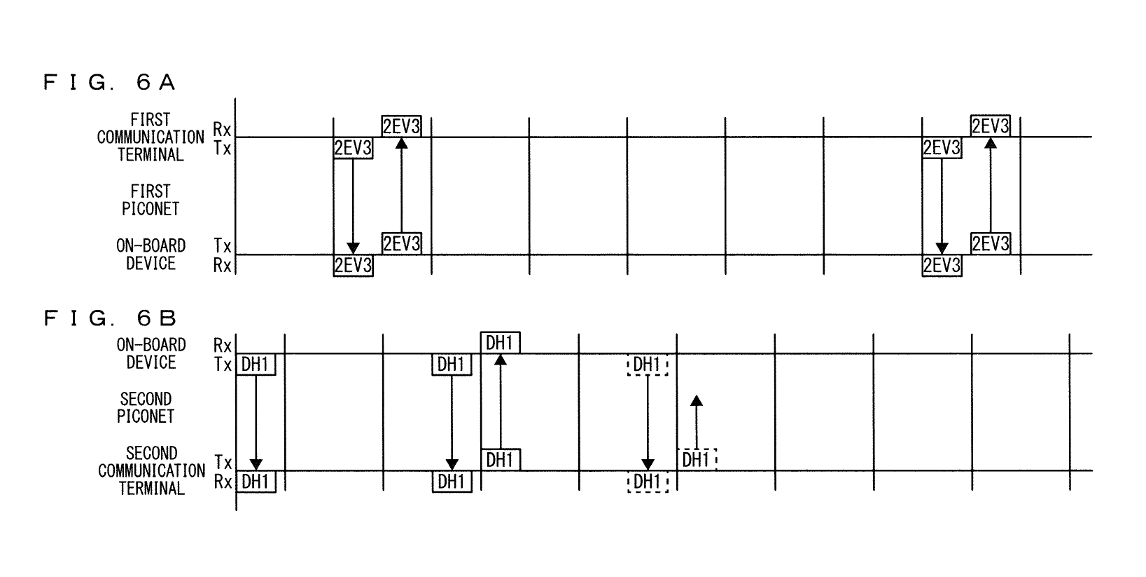

Herein, the extended synchronization packet may be a packet indicating whether an extended SCO (eSCO) link obtained by developing, for example, an SCO link illustrated in FIG. 4(a) can be used. The eSCO will be described briefly with reference to FIGS. 4(a), 4(b), 6(a), and 6(b).

The SCO link illustrated in FIG. 4(a) has regular intervals (cycles) at which packets are repeatedly transmitted and received. In the use of the SCO link, thus, the communication operations of the first and second piconets collide with each other as illustrated in FIGS. 4(a) and 4(b).

Meanwhile, the eSCO link has variable intervals (cycles) at which packets are repeatedly transmitted and received, resulting in a higher degree of flexibility in the intervals. In the use of the eSCO link, thus, the intervals at which packets are repeatedly transmitted and received are changed appropriately as illustrated in FIGS. 6(a) and 6(b), to thereby eliminate or reduce the collisions of the communication operations between the first and second piconets. The on-board device 1 according to the first embodiment, which is configured to check an extended synchronization packet and then use the eSCO link or any other link, can eliminate or reduce the collisions of the communication operations between different piconets, that is, reduce the frequency of collision.

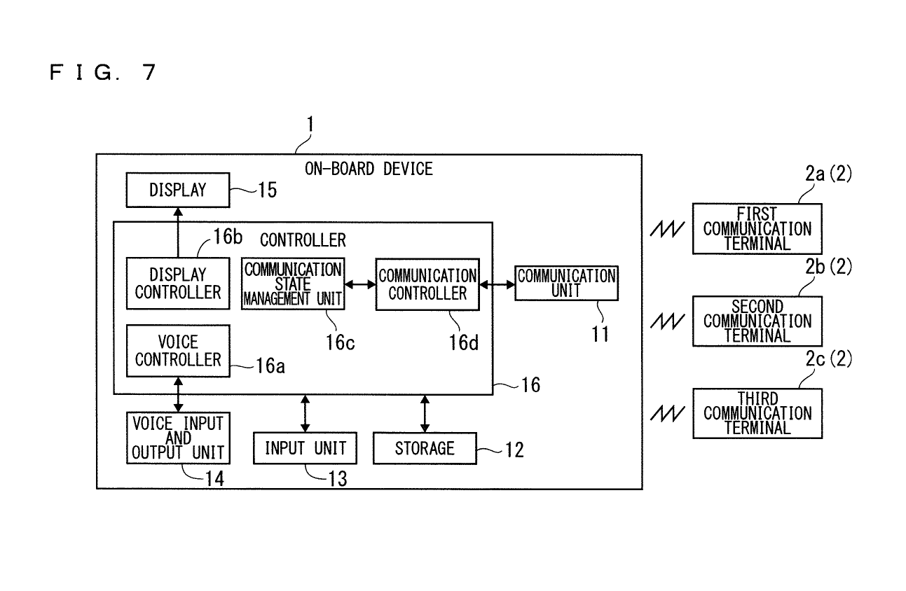

The following will describe not only the main constituent elements of the on-board device 1 but also the additional constituent elements thereof. FIG. 7 is a block diagram illustrating the main and additional configurations of the on-board device 1 according to the first embodiment. The on-board device 1 of FIG. 7 includes a storage 12, an input unit 13, a voice input and output unit 14, and a display 15, in addition to the communication unit 11 and the controller 16 described above. Although FIG. 7 illustrates an example in which the on-board device 1 performs Bluetooth communication with three communication terminals 2 (a first communication terminal 2a, a second communication terminal 2b, and a third communication terminal 2c), the number of communication terminals 2 that perform this communication with the on-board device 1 is not limited to this number.

The controller 16 performs overall control of the constituent elements of the on-board device 1. The controller 16 of FIG. 7 has the functions of a voice controller 16a, a display controller 16b, a communication state management unit 16c, and a communication controller 16d.

The storage 12 stores the information necessary for the on-board device 1 to perform Bluetooth communication (e.g., set values such as parameters). The storage 12 is, for example, mainly composed of a storage device such as a hard disk drive (HDD), digital versatile disc (DVD), or semiconductor memory.

The input unit 13 receives actions from the user and outputs signals corresponding to the actions to the controller 16. The input unit 13 is, for example, composed of at least one of a button and a touch panel that output a signal in response to a manual action of the user, and another appropriate input device.

The voice input and output unit 14 inputs a voice signal based on the received voice to the voice controller 16a and externally outputs a voice based on the voice signal output from the voice controller 16a.

The display 15 displays, for example, images and icons based on the image signals output from the display controller 16b.

The following will describe the individual functions (individual constituent elements) of the controller 16 in detail. The voice controller 16a controls the voice of the voice input and output unit 14, and the display controller 16b controls the display of the display 15.

The communication state management unit 16c is implemented by, for example, middleware and manages, for example, the roles (master/slave) that are assumed by the communication unit 11, the states of a Bluetooth connection with the communication terminal 2 (such as profiles), and the types of packets available in the communication between the communication unit 11 and the communication terminal 2, and also makes various determinations. Additionally, the communication state management unit 16c instructs the communication unit 11 to perform the setting necessary for Bluetooth communication, such as a role switch, via the communication controller 16d.

The communication controller 16d performs command control on the communication unit 11 based on the instruction from the communication state management unit 16c.

<Operation>

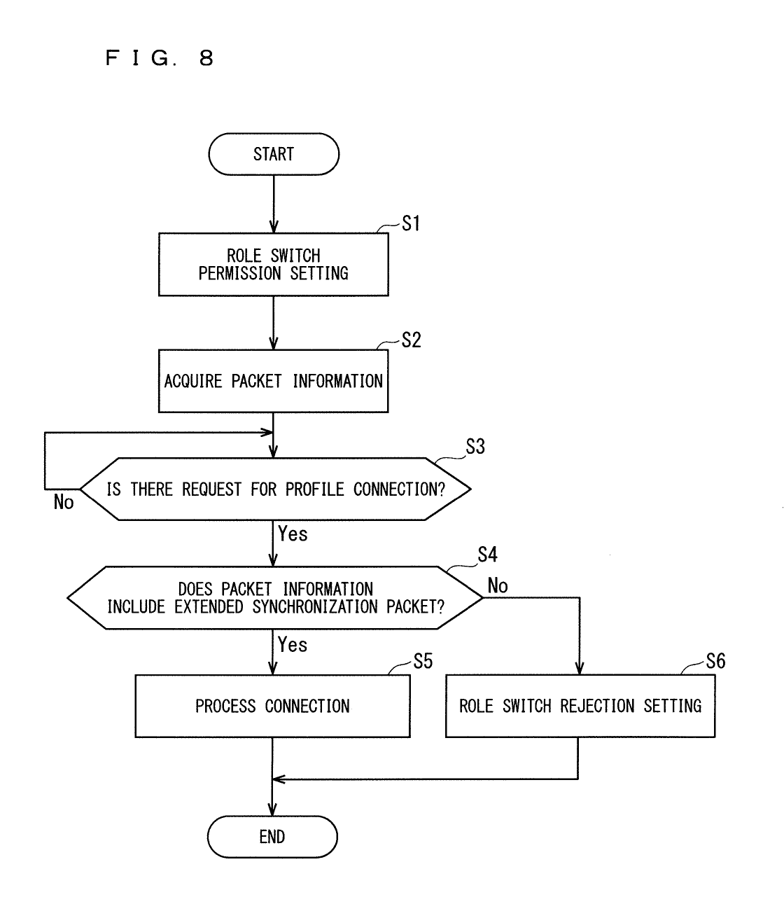

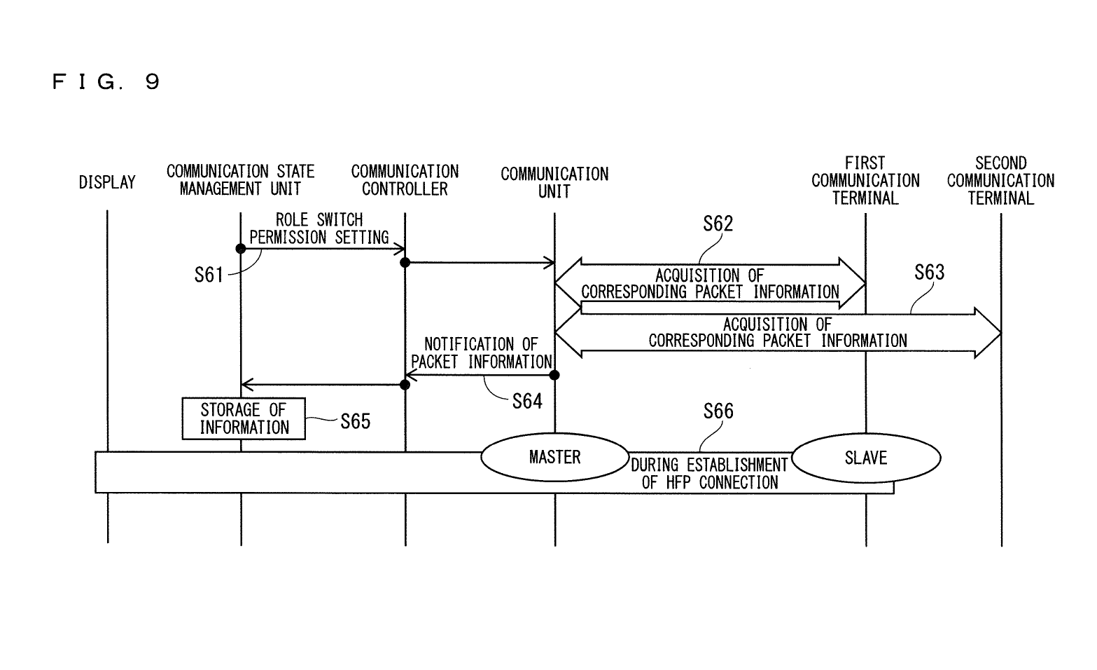

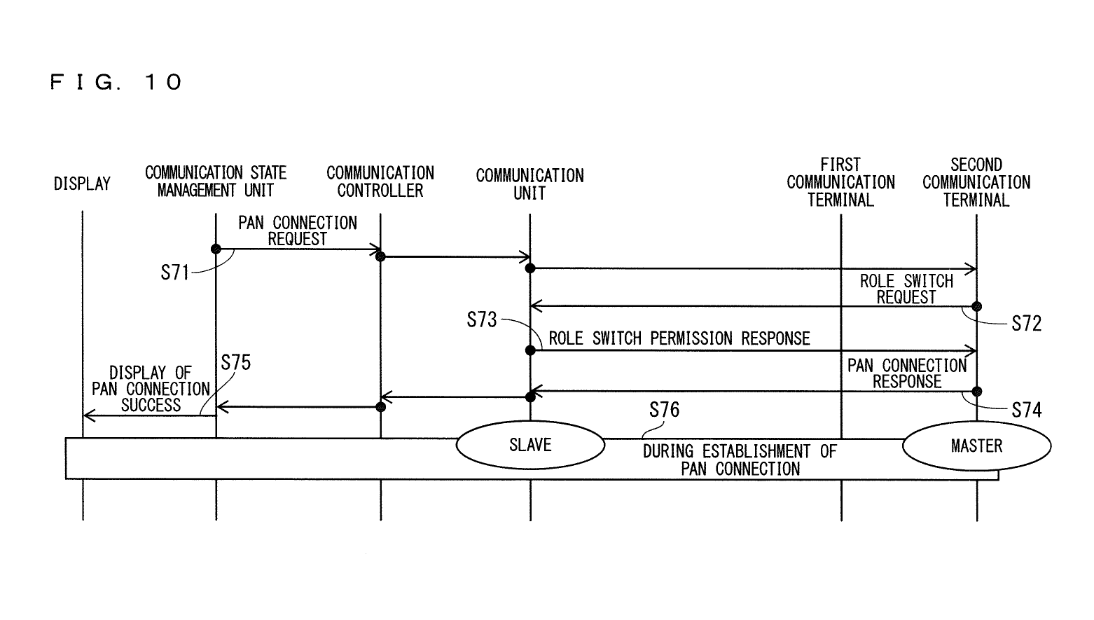

FIG. 8 is a flowchart illustrating the operation of the on-board device 1 according to the first embodiment, and FIGS. 9, 10, and 11 are sequence diagrams illustrating the operation of the on-board device 1.

First, in Step S1 of FIG. 8, setting to permit a role switch is performed. In Step S2, then, the communication unit 11 communicates with the communication terminal 2 to acquire packet information (corresponding packet information).

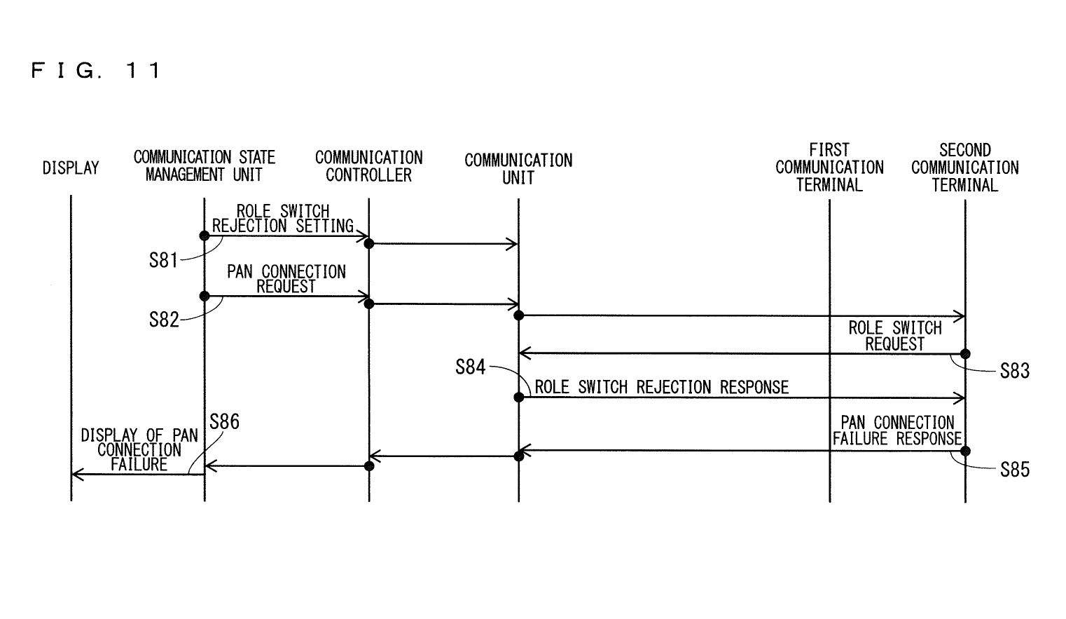

Steps S1 and S2 correspond to Steps S61 to S65 of FIG. 9. Specifically, in Step S61, the communication state management unit 16c performs, on the communication unit 11, setting to permit a role switch via the communication controller 16d. In Step S62, the communication unit 11 transmits and receives the packet information to and from the first communication terminal 2a, and in Step S63, the communication unit 11 transmits and receives the corresponding packet information to and from the second communication terminal 2b. It should be noted that the timing of Step S63 is not limited to the timing illustrated in FIG. 9, and for example, Step S63 may be performed after Step S71 of FIG. 10.

In Step S64, the communication unit 11 notifies, via the communication controller 16d, the communication state management unit 16c of the packet information acquired in the transmission and reception, and in Step S65, the communication state management unit 16c stores (holds) the packet information. It should be noted that description will be given below assuming that in Step S66 following Step S65, HFP connection in which the communication unit 11 is a master and the first communication terminal 2a is a slave is established between the communication unit 11 and the first communication terminal 2a.

Referring back to FIG. 8, in Step S3, the communication state management unit 16c determines whether there is a profile connection request between the communication unit 11 and a communication terminal 2. Description will be given below assuming that the communication terminal 2 is the second communication terminal 2b. The communication state management unit 16c determines that there is a connection request and proceeds to Step S4 if the input unit 13 receives an action corresponding to a connection request, or otherwise, determines that there is no connection request and performs Step S3 again.

In Step S4, the communication state management unit 16c determines whether the packet information from the first communication terminal 2a being in HFP connection therewith includes an extended synchronization packet. The process proceeds to Step S5 if the communication state management unit 16c determines that an extended synchronization packet is included, or otherwise, proceeds to Step S6.

When the process proceeds from Step S4 to Step S5, the on-board device 1 and the second communication terminal 2b establish a profile connection, and the display 15 displays the connection result. After that, the operation of FIG. 8 ends.

Step S5 corresponds to Steps S71 to S76 of FIG. 10. Although the example of FIG. 10 will be given assuming that a profile connection request is a PAN connection request, the profile connection request is not limited to this request.

In Step S71, the communication state management unit 16c requests a profile connection (herein, PAN connection) from the second communication terminal 2b via the communication controller 16d and the communication unit 11. When receiving the request for a PAN connection from the on-board device 1, in Step S72, the second communication terminal 2b requests a role switch from the on-board device 1.

When receiving the request for a role switch from the second communication terminal 2b, in Step S73, the communication unit 11 responds to the second communication terminal 2b with permission to perform a role switch. When receiving the response to permit a role switch from the on-board device 1, in Step S74, the second communication terminal 2b responds to the on-board device 1 with a PAN connection. When receiving the PAN connection response from the second communication terminal 2b via the communication unit 11 and the communication controller 16d, in Step S75, the communication state management unit 16c causes the display 15 to display that the PAN connection has succeeded.

As a result of the role of the communication unit 11 for the second communication terminal 2b being switched from a master to a slave, in Step S76, a PAN connection in which the communication unit 11 is a slave and the second communication terminal 2b is a master is established between the communication unit 11 and the second communication terminal 2b.

When the process proceeds from Step S4 to Step S6 of FIG. 8, meanwhile, the on-board device 1 and the second communication terminal 2b perform setting to reject a role switch, and if the establishment of the profile connection fails, the display 15 displays that the profile connection has failed. After that, the operation of FIG. 8 ends.

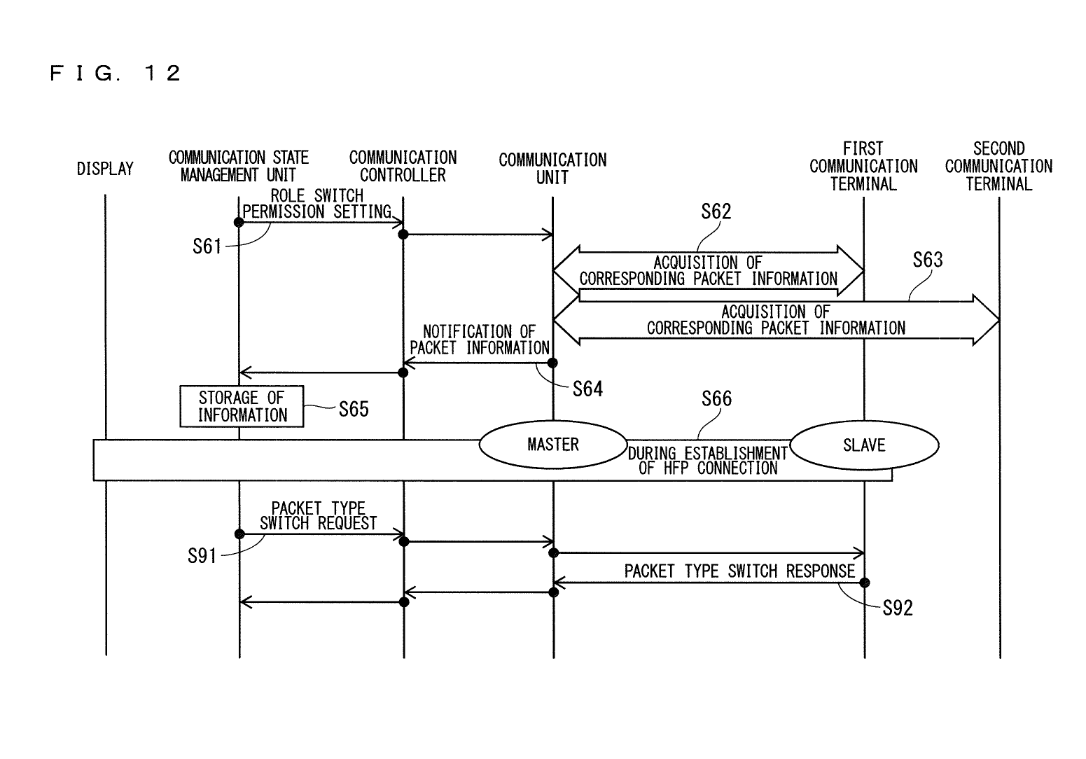

Step S6 corresponds to Steps S81 to S86 of FIG. 11. Although the example of FIG. 11 will be given assuming that the profile connection request is a PAN connection request, the profile connection request is not limited to this request.

In Step S81, the communication state management unit 16c performs, on the communication unit 11, setting to reject a role switch via the communication controller 16d. In Step S82, the communication state management unit 16c requests a profile connection (herein, a PAN connection) from the second communication terminal 2b via the communication controller 16d and the communication unit 11. When receiving the request for a PAN connection from the on-board device 1, in Step S83, the second communication terminal 2b requests a role switch from the on-board device 1.

When receiving the request for a role switch from the second communication terminal 2b, in Step S84, the communication unit 11 responds to the second communication terminal 2b with rejection of a role switch. When the second communication terminal 2b receives the response of rejection of a role switch from the on-board device 1 and does not accept a role switch rejection, in Step S85, the second communication terminal 2b responds to the on-board device 1 with a failure of the PAN connection. When receiving the response of the PAN connection failure from the second communication terminal 2b via the communication unit 11 and the communication controller 16d, in Step S86, the communication state management unit 16c causes the display 15 to display that the PAN connection has failed.

<Effects>

The on-board device 1 according to the first embodiment as described above inhibits a switch of the role of the communication unit 11 from a master to a slave when no extended synchronization packet is included in the packet information transmitted to the communication unit 11 from the communication terminal 2 communicating with the communication unit 11 using the HFP. As a result, collisions of the communication operations between different piconets are eliminated or reduced, thus enabling appropriate communication with the communication terminal 2 that assumes only the role of a master while avoiding a conventional problem, that is, a disconnection of the AVP communication in a scatternet connection.

### Second Embodiment

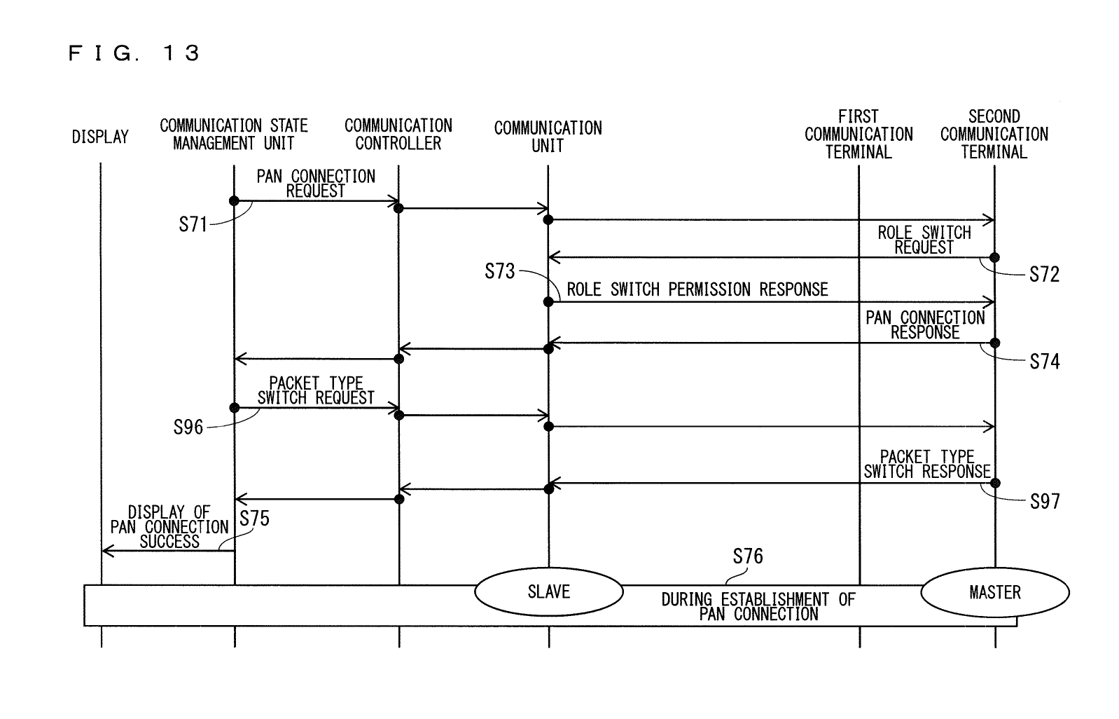

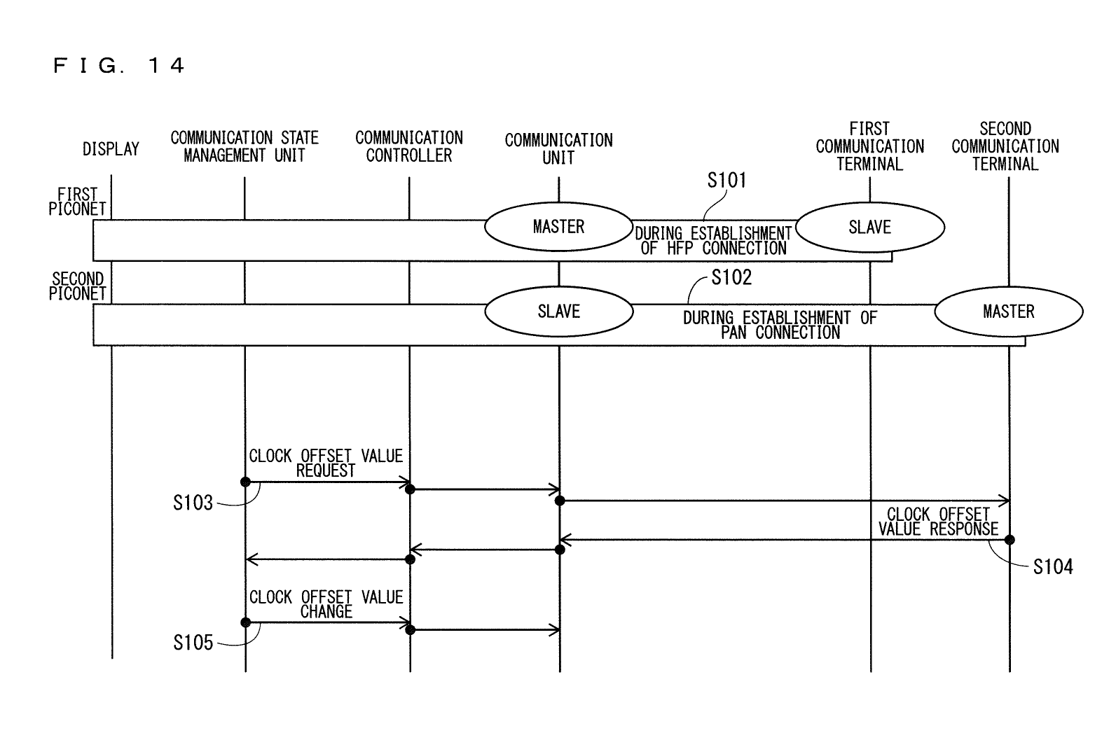

FIGS. 12 and 13 are sequence diagrams illustrating the operation of an on-board device 1 according to a second embodiment of the present invention. Block diagrams illustrating the configurations of the on-board devices 1 according to the second embodiment and the following embodiments are similar to the block diagrams (FIGS. 5 and 6) of the on-board device 1 according to the first embodiment. The constituent elements of the on-board device 1 according to the second embodiment and the following embodiments, which are identical or similar to the constituent elements described above, will bear the same reference signs, and differences will be mainly described.

A controller 16 according to the second embodiment is configured to change, based on the profiles used by a communication unit 11 in individual communications with a plurality of communication terminals 2, the types of packets to be assigned to the individual communications.

The operation of the on-board device 1 configured as described above will be described below with reference to FIGS. 12 and 13. The operation of FIG. 12 corresponds to the operation of FIG. 9 to which Steps S91 and S92 are added, and the operation of FIG. 13 corresponds to the operation of FIG. 10 to which Steps S96 and S97 are added. Thus, the following will mainly describe Steps S91, S92, S96, and S97. Also, the description will be given below assuming that the communication unit 11 and a first communication terminal 2a communicate with each other using the HFP, and the communication unit 11 and a second communication terminal 2b communicate with each other using the PAN.

First, the operation of FIG. 12 will be described. After Step S66, in Step S91, a communication state management unit 16c requests, via a communication controller 16d and the communication unit 11, the first communication terminal 2a to switch a packet type. Herein, the communication state management unit 16c requests the communication terminal 2, which uses the HFP similarly to the first communication terminal 2a, to switch a packet type such that the communication terminal 2 uses a packet with a relatively long interval between packet transmission and reception.

When receiving the request to switch a packet type from the on-board device 1, in Step S92, the first communication terminal 2a switches to a packet of the requested type and responds to the on-board device 1 with the use of the relevant packet in the subsequent communication. After that, the communication state management unit 16c receives the response from the first communication terminal 2a via the communication unit 11 and the communication controller 16d, so that the packet of the requested type is used in the communication between the communication unit 11 and the first communication terminal 2a.

The following will describe the operation of FIG. 13. After Step S74, in Step S96, the communication state management unit 16c requests, via the communication controller 16d and the communication unit 11, the second communication terminal 2b to switch a packet type. Herein, the communication state management unit 16c requests the communication terminal 2, which uses the PAN similarly to the second communication terminal 2b, and the communication terminal 2 (not shown), which uses the AVP, to switch a packet type such that the communication terminal 2 uses a packet with a relatively short packet length.

When receiving the request to switch a packet type from the on-board device 1, in Step S97, the second communication terminal 2b switches to a packet of the requested type and responds to the on-board device 1 with the use of the relevant packet in the subsequent communication. After that, the communication state management unit 16c receives the response from the second communication terminal 2b via the communication unit 11 and the communication controller 16d, so that the packet of the requested type is used in the communication between the communication unit 11 and the second communication terminal 2b.

<Effects>

The on-board device 1 according to the second embodiment as described above changes, based on the profiles used by the communication unit 11 in individual communications with a plurality of communication terminals 2, the types of packets to be assigned to the individual communications. Consequently, collisions of communication operations between different piconets can be eliminated or reduced, thus enabling appropriate communication with the communication terminal 2 that assumes only the role of a master while avoiding a conventional problem, that is, a disconnection of AVP communication in a scatternet connection.

### Third Embodiment

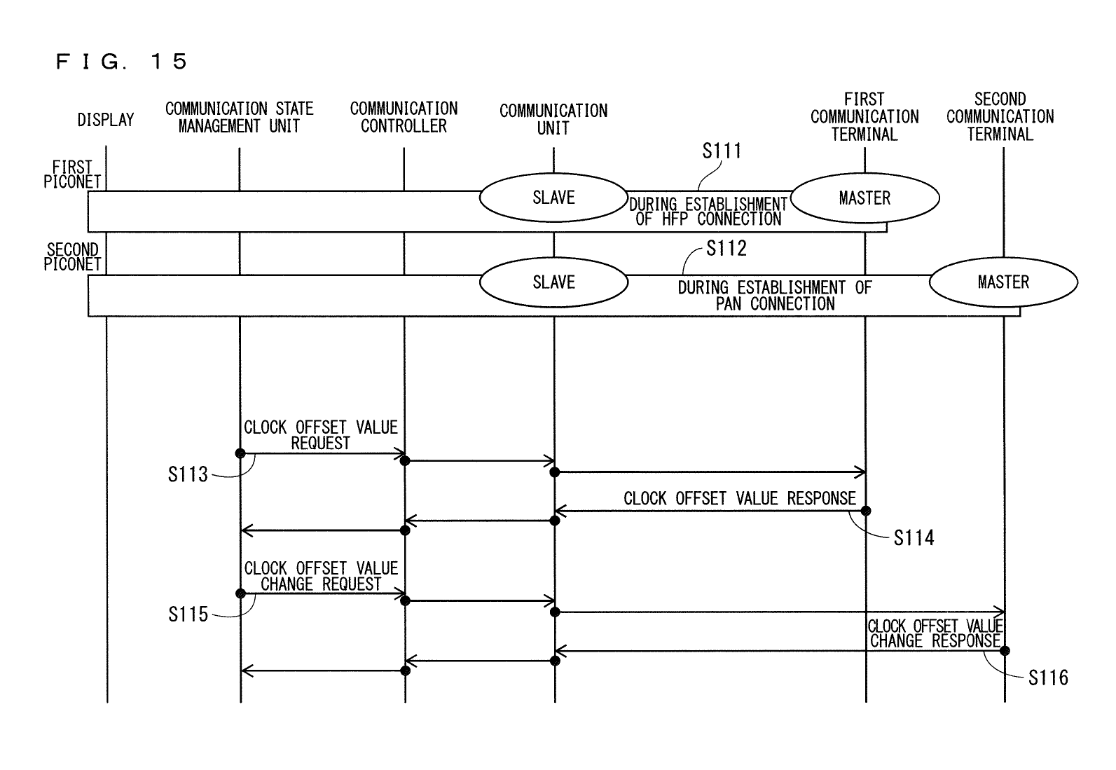

FIG. 14 is a sequence diagram illustrating the operation of an on-board device 1 according to a third embodiment of the present invention.

A controller 16 according to the third embodiment is configured to, when a communication unit 11 assumes the role of a master for a communication terminal 2 to form a first piconet and the communication unit 11 assumes the role of a slave for another communication terminal 2 to form a second piconet, set an offset value of a synchronization clock of the second piconet in the first piconet.

The operation of the on-board device 1 configured as described above will be described below with reference to FIG. 14.

In the example of FIG. 14, in Step S101, the communication unit 11 assumes the role of a master for a first communication terminal 2a to form a first piconet. In Step S102, the communication unit 11 assumes the role of a slave for a second communication terminal 2b to form a second piconet. That is to say, a scatternet connection is formed in the on-board device 1.

In such a case, in Step S103, a communication state management unit 16c requests a clock offset value of the second piconet from the second communication terminal 2b via the communication controller 16d and the communication unit 11. When receiving the request for the clock offset value of the second piconet from the on-board device 1, in Step S104, the second communication terminal 2b responds to the on-board device 1 with the clock offset value of the second piconet.

When receiving the response of the clock offset value of the second piconet from the second communication terminal 2b via the communication unit 11 and the communication controller 16d, in Step S105, the communication state management unit 16c causes the communication unit 11 to change the synchronization timing of the first piconet such that the clock offset value of the second piconet is set to the clock offset value of the first piconet.

<Effects>

In the third embodiment as described above, when the communication unit 11 assumes the role of a master for the first communication terminal 2a to form a first piconet and the communication unit 11 assumes the role of a slave for the second communication terminal 2b to form a second piconet, the offset value of the synchronization clock of the second piconet is set in the first piconet. This corrects a difference between the synchronization timing of the first piconet and the synchronization timing of the second piconet. Consequently, collisions of the communication operations between different piconets can be further eliminated or reduced, thus further eliminating or reducing malfunctions such as a disconnection of the voice that is output using the AVP and retransmission of packets during the PAN connection.

### Fourth Embodiment

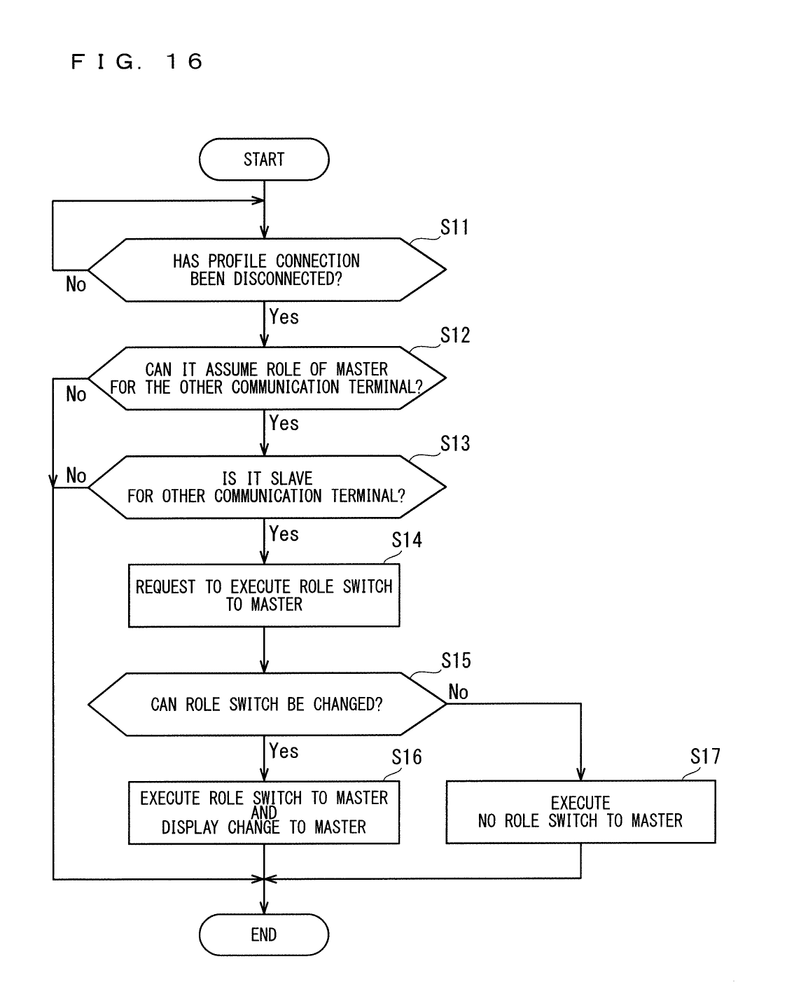

FIG. 15 is a sequence diagram illustrating the operation of an on-board device 1 according to a fourth embodiment of the present invention.

A controller 16 according to the fourth embodiment is configured to, when a communication unit 11 assumes the role of a slave for a communication terminal 2 to form a first piconet and the communication unit 11 assumes the role of a slave for another communication terminal 2 to form a second piconet, set an offset value of a synchronization clock of one of the first piconet and the second piconet in the other.

The operation of the on-board device 1 configured as described above will be described below with reference to FIG. 15.

In the example of FIG. 15, in Step S111, the communication unit 11 assumes the role of a slave for a first communication terminal 2a to form a first piconet. In Step S112, the communication unit 11 assumes the role of a slave for a second communication terminal 2b to form a second piconet. That is to say, a scatternet connection is formed in the on-board device 1.

In such a case, in Step S113, a communication state management unit 16c requests a clock offset value of the first piconet from the first communication terminal 2a via a communication controller 16d and the communication unit 11. When receiving the request for a clock offset value from the on-board device 1, in Step S114, the first communication terminal 2a responds to the on-board device 1 with the clock offset value of the first piconet.

When receiving the response of the clock offset value of the first piconet from the first communication terminal 2a via the communication unit 11 and the communication controller 16d, in Step S115, the communication state management unit 16c transmits the clock offset value of the first piconet and a request to change the clock offset value to the second communication terminal 2b via the communication controller 16d and the communication unit 11. When receiving the clock offset value of the first piconet and the request to change the clock offset value from the on-board device 1, in Step S116, the second communication terminal 2b sets the clock offset value of the first piconet to the clock offset value of the second piconet.

The second communication terminal 2b performs a calculation necessary for changing a clock offset value (e.g., a difference between the clock offset value of the first piconet and the clock offset value of the second piconet) in the description above, which is not limited to the above. Alternatively, the communication state management unit 16c or the like may perform such a calculation. Although the clock offset value of the first piconet is set to the clock offset value of the second piconet in the description above, the clock offset value of the second piconet may be set to the clock offset value of the first piconet.

<Effects>

In the fourth embodiment as described above, when the communication unit 11 assumes the role of a slave for the first communication terminal 2a to form a first piconet and the communication unit 11 assumes the role of a slave for the second communication terminal 2b to form a second piconet, the offset value of the synchronization clock of one of the first piconet and the second piconet is set in the other. This corrects a discrepancy between the synchronization timing of the first piconet and the synchronization timing of the second piconet. Consequently, collisions of the communication operations between different piconets can be further eliminated or reduced, thus further eliminating or reducing malfunctions such as a disconnection of the voice that is output using the AVP and retransmission of packets during the PAN connection.

### Fifth Embodiment

A controller 16 according to a fifth embodiment of the present invention is configured to, when the role of a communication unit 11 for a communication terminal 2 is switched to a slave in communication between the communication unit 11 and another communication terminal 2, return the role of the communication unit 11 for the communication terminal 2 to a master in disconnection of the communication between the communication unit 11 and the other communication terminal 2.

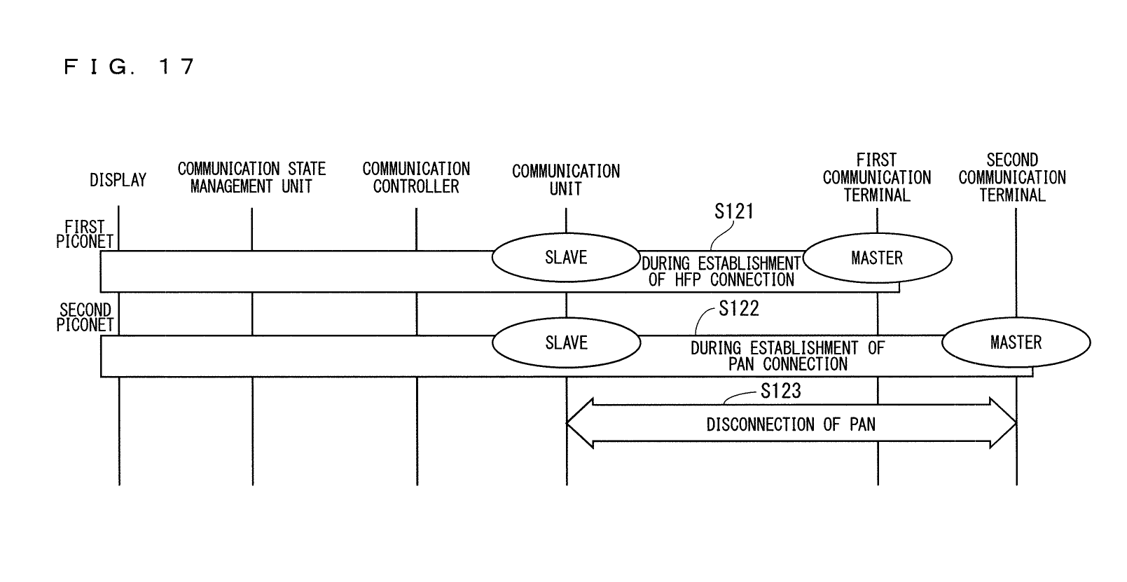

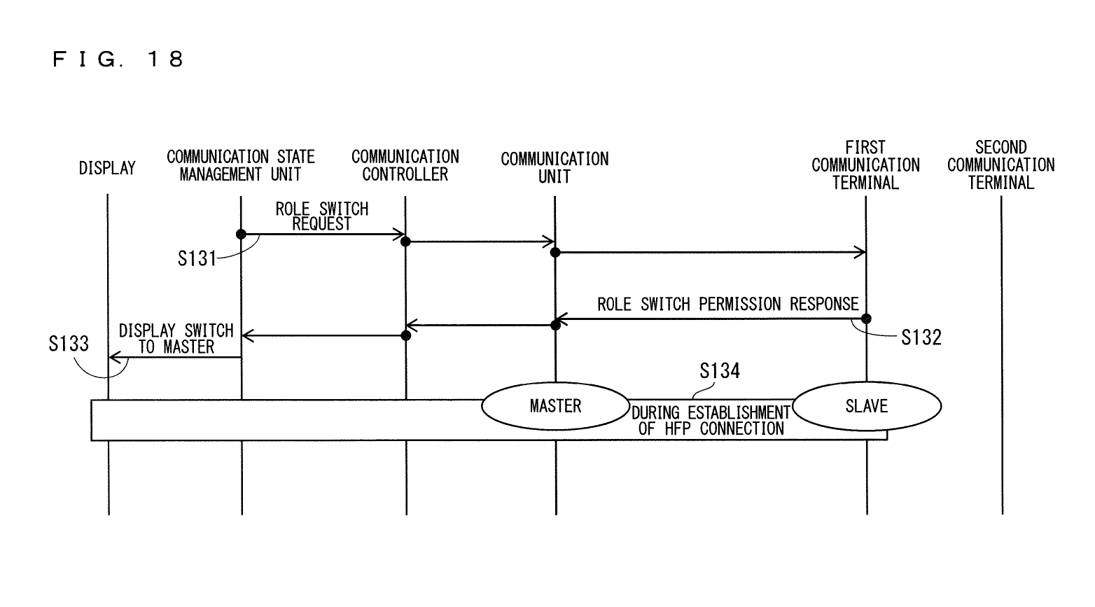

FIG. 16 is a flowchart illustrating the operation of an on-board device 1 according to the fifth embodiment of the present invention, and FIGS. 17, 18, and 19 are sequence diagrams illustrating the operation of the on-board device 1. Description will be given below assuming that the role of the communication unit 11 for a first communication terminal 2a is also switched to a slave when the communication unit 11 performs a profile connection with a second communication terminal 2b.

First, in Step S11 of FIG. 16, a communication state management unit 16c determines whether the second communication terminal 2b performing profile connection with the communication unit 11 has disconnected this connection. The communication state management unit 16c proceeds to Step S11 if the disconnection has been determined, or otherwise, performs Step S11 again.

For example, in the example sequence of FIG. 17, in Step S121, the communication unit 11 assumes the role of a slave for the first communication terminal 2a to form a first piconet in which an HFP connection is being established. In Step S122, the communication unit 11 assumes the role of a slave for the second communication terminal 2b to form a second piconet in which the PAN connection is being established. In Step S123, then, the PAN connection between the communication unit 11 and the second communication terminal 2b is disconnected. In such a case, the process proceeds to Step S12. Although the disconnection of the PAN connection has been described as an example of the profile connection with reference to FIG. 17, the disconnection of the profile connection is not limited to this disconnection.

Referring back to FIG. 16, in Step S12, the communication state management unit 16c determines whether it can assume the role of a master for the other communication terminal 2 (herein, the first communication terminal 2a) communicating with the communication unit 11 using a profile. The process proceeds to Step S13 if the communication state management unit 16c determines that it can assume the role of a master, or otherwise, the operation of FIG. 16 ends.

In Step S13, the communication state management unit 16c determines whether it is assuming the role of a slave for the other communication terminal 2 (herein, the first communication terminal 2a). The process proceeds to Step S14 if the communication state management unit 16c determines that it is assuming the role of a slave, or otherwise, the operation of FIG. 16 ends.

In Step S14, the communication state management unit 16c requests a role switch from the other communication terminal 2 (herein, the first communication terminal 2a) assuming the role of a master for the on-board device 1.

In Step S15, the communication terminal 2 (herein, the first communication terminal 2a) that has been requested to perform a role switch determines whether it can change a role switch. The process proceeds to Step S16 if it is determined that a role switch can be changed, or otherwise, the process proceeds to Step S17.

When the process proceeds from Step S15 to Step S16, the on-board device 1 and the communication terminal 2 (herein, the first communication terminal 2a) that has been requested to perform a role switch perform a role switch, and also display, with an icon, that the on-board device 1 has been changed to a master. After that, the operation of FIG. 16 ends.

Steps S14 and S16 correspond to Steps S131 to S134 of FIG. 18. For example, in Step S131, the communication state management unit 16c requests a role switch from the first communication terminal 2a assuming the role of a master via the communication controller 16d and the communication unit 11. When receiving the request for a role switch from the on-board device 1, in Step S132, the first communication terminal 2a responds to the on-board device 1 with permission to perform a role switch.

When receiving the response to permit a role switch from the first communication terminal 2a via the communication unit 11 and the communication controller 16d, in Step S133, the communication state management unit 16c causes the display 15 to display an icon indicating that the on-board device 1 has been switched to a master. As a result of the switch of the role of the communication unit 11 from a slave to a master, in Step S134, an HFP connection in which the communication unit 11 is a master and the first communication terminal 2a is a slave is established between the communication unit 11 and the first communication terminal 2a.

Referring back to FIG. 16, when the process proceeds from Step S15 to Step S17, the on-board device 1 and the communication terminal 2 (herein, the first communication terminal 2a) that has been requested to perform a role switch do not perform a role switch. After that, the process of FIG. 16 ends.

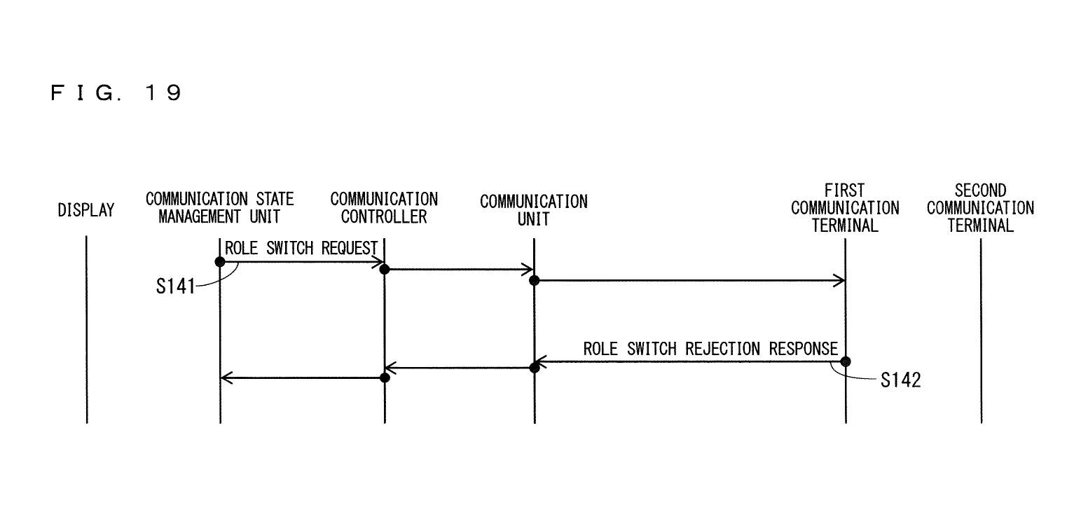

Steps S14 and S17 correspond to Steps S141 and S142 of FIG. 19. For example, in Step S141, the communication state management unit 16c requests a role switch from the first communication terminal 2a assuming the role of a master via the communication controller 16d and the communication unit 11. When receiving the request for a role switch from the on-board device 1, in Step S142, the first communication terminal 2a responds to the on-board device 1 with rejection of a role switch. After that, the communication state management unit 16c receives the response to reject a role switch from the first communication terminal 2a via the communication unit 11 and the communication controller 16d.

<Effects>

The on-board device 1 according to the fifth embodiment as described above returns, when the role of the communication unit 11 for the first communication terminal 2a is switched to a slave in the communication between the communication unit 11 and the second communication terminal 2b, the role of the communication unit 11 for the first communication terminal 2a to a master in the disconnection of the communication between the communication unit 11 and the second communication terminal 2b. The communication unit 11 (on-board device 1) can thus assume the role of a master whenever possible, thereby reducing a possibility that a scatternet will be formed in the on-board device 1.

### Sixth Embodiment

A display 15 according to a sixth embodiment of the present invention displays the roles of a master and a slave of an on-board device 1 and a plurality of communication terminals 2, and the profiles and the types of packets used in the communications between the on-board device 1 and the plurality of communication terminals 2.

FIG. 20 illustrates a display example of the display 15 when the on-board device 1 communicates with two communication terminals 2. In this figure, a rectangular frame 15a corresponds to the on-board device 1, where an “M” inside the frame 15a indicates that the on-board device 1 assumes the role of a master and “S” inside the frame 15a indicates that the on-board device 1 assumes the role of a slave. In the display example of FIG. 20, since there are “M” and “S” inside the frame 15a, a scatternet connection is formed in the on-board device 1.

“M” outside the frame 15a indicates that the communication terminal 2 communicating with the on-board device 1 using a profile assumes the role of a master, and “S” outside the frame 15a indicates that the communication terminal 2 communicating with the on-board device 1 using a profile assumes the role of a slave.

A symbol 15b, composed of graphics indicating an antenna and longitudinal lines whose number varies depending on the received signal strength, indicates that the on-board device 1 and the communication terminal 2 assuming the role (“S” or “M”) to which the symbol 15b is added perform communication with each other using the HFP. A symbol 15c composed of graphics indicating the audio play state indicates that the on-board device 1 and the communication terminal 2 assuming the role (“S” or “M”) to which the symbol 15c is added perform communication with each other using the AVP. In the display example of FIG. 20, graphics indicating audio play are applied to the symbol 15c, which is not limited thereto. Alternatively, graphic indicating forward, graphics indicating skip, graphics indicating pause, or any other graphics may be appropriately applied.

Arrows 15d and 15e indicate the types of packets used in the communication of the on-board device 1 and the communication terminal 2. For example, the arrow 15d by a solid line indicates that the on-board device 1 and the communication terminal 2 that are displayed on the opposite sides thereof communicate with each other using a synchronization packet such as an SCO packet. Also, for example, the arrow 15e by a dotted line indicates that the on-board device 1 and the communication terminal 2 that are displayed on the opposite sides thereof communicate with each other using an asynchronization packet such as an ACL packet. It should be noted that the character “e” added to above the arrow 15d by a solid line indicates that the on-board device 1 and the communication terminal 2 that are displayed on the opposite sides thereof communicate with each other using an extended synchronization packet.

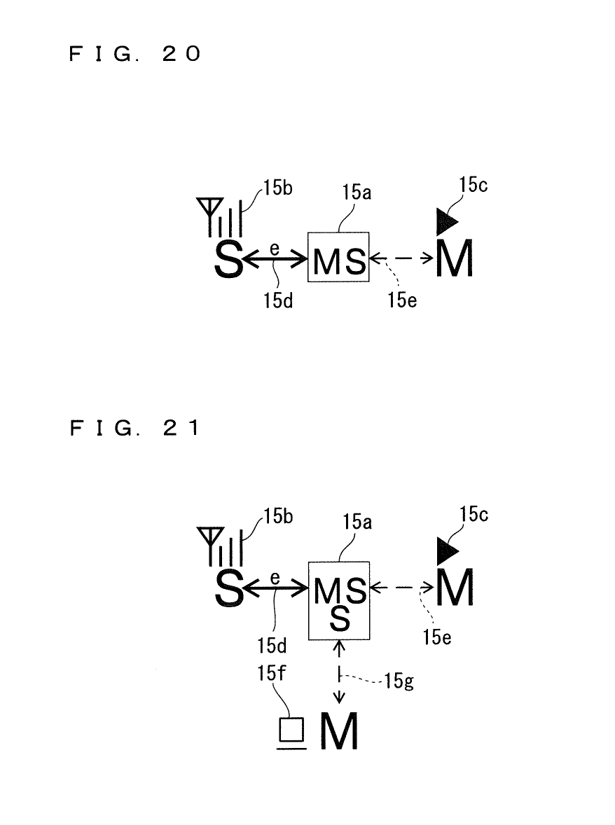

FIG. 21 illustrates a display example of the display 15 in the communication of the on-board device 1 with three communication terminals 2. In the display example of FIG. 21, the on-board device 1 assumes the role of a master for one communication terminal 2 and assumes the role of a slave for the other two communication terminals 2.

In the display example of FIG. 21, a symbol 15f and an arrow 15g are added to the display example of FIG. 20. The symbol 15f having an approximately outer appearance of a personal computer indicates that the on-board device 1 and the communication terminal 2 assuming the role (“S” or “M”) to which the symbol 15f is added communicate with each other using a data communication profile such as the PAN. The arrow 15g by a dotted line indicates the details similar to those of the arrow 15e by a dotted line.

<Effects>

The on-board device 1 according to the sixth embodiment as described above displays the roles of the master or slave of the on-board device 1 and a plurality of communication terminals 2, and the profiles and the types of packets used in the communications between the on-board device 1 and the plurality of communication terminals 2. This enables the user to easily grasp the states of communications between the on-board device 1 and a plurality of communication terminals 2.

### Seventh Embodiment

The controllers 16 described above can switch the role of the communication unit 11 from a master to a slave when an extended synchronization packet is included in the packet information transmitted to the communication unit 11 from the communication terminal 2 communicating with the communication unit 11 using the HFP. In contrast, a controller 16 according to a seventh embodiment of the present invention can switch the role of a communication unit 11 from a master to a slave except in the case in which the communication unit 11 communicates with a plurality of communication terminals 2 using both of the HFP and AVP.

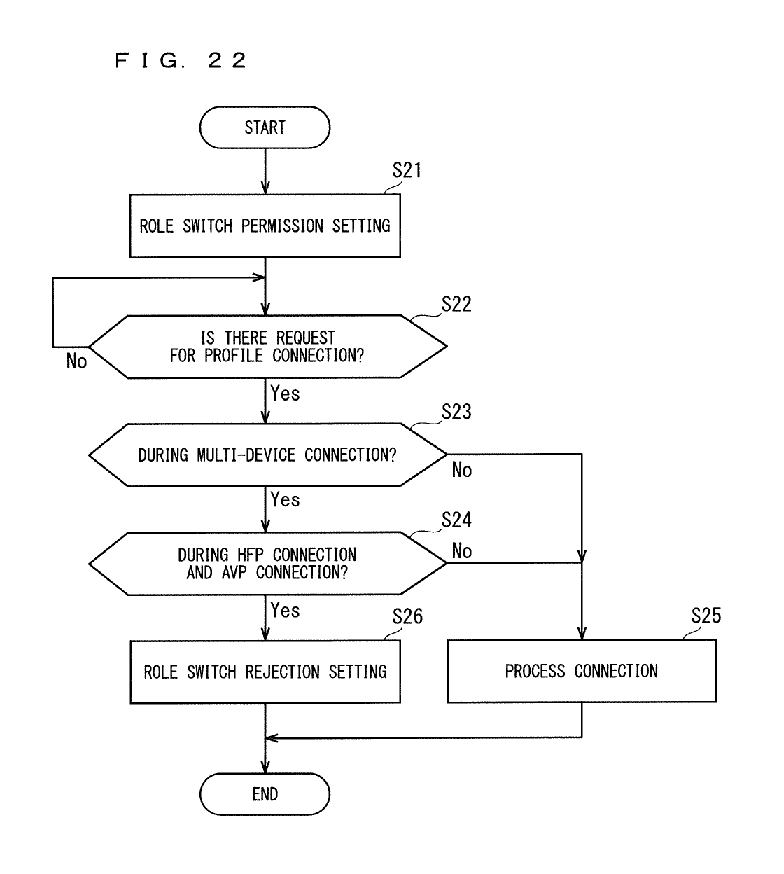

FIG. 22 is a flowchart illustrating the operation of an on-board device 1 according to the seventh embodiment.

First, in Step S21 of FIG. 22, a communication state management unit 16c performs, on the communication unit 11, setting to permit a role switch via a communication controller 16d. In Step S22, the communication state management unit 16c determines whether there is a profile connection request between the communication unit 11 and a communication terminal 2. Description will be given below assuming that the communication ten final 2 is a third communication terminal 2c. The communication state management unit 16c determines that there is a connection request and proceeds to Step S23 if the input unit 13 receives an action corresponding to the connection request, or otherwise, determines that there is no connection request and performs Step S22 again.

In Step S23, the communication state management unit 16c determines whether the communication unit 11 is during multi-device connection. In other words, the communication state management unit 16c determines whether the communication unit 11 is in communication connection with a plurality of communication terminals 2. The cases in which the communication unit 11 is not in communication connection with a plurality of communication terminals 2 supposedly include the case in which the communication unit 11 is in communication connection with one communication terminal 2 and the case in which the communication unit 11 is in communication connection with no communication terminal 2. The process proceeds to Step S24 if it is determined that the communication unit 11 is in communication connection with a plurality of communication terminals 2, or proceeds to Step S25 if it is determined that the communication unit 11 is not in communication connection with a plurality of communication terminals 2.

In Step S24, the communication state management unit 16c determines whether there is a communication terminal 2 with which the communication unit 11 is in HFP connection and AVP connection among a plurality of communication terminals 2. In other words, the communication state management unit 16c determines whether both of the HFP and AVP are used in the communications between the communication unit 11 and a plurality of communication terminals 2. The process proceeds to Step S26 if it is determined that the communication unit 11 is in HFP connection and AVP connection with a plurality of communication terminals 2, or otherwise, proceeds to Step S25.

When the process proceeds from Step S23 or S24 to Step S25, as in Step S5 (FIG. 8) described above, the on-board device 1 and the third communication terminal 2c establish a profile connection and display the display result. After that, the operation of FIG. 22 ends.

Meanwhile, when the process proceeds from Step S24 to Step S26, as in Step S6 (FIG. 8) described above, the on-board device 1 and the third communication terminal 2c perform setting to reject a role switch, and when the establishment of a profile connection fails, the display 15 displays that the profile connection has failed. After that, the operation of FIG. 22 ends.

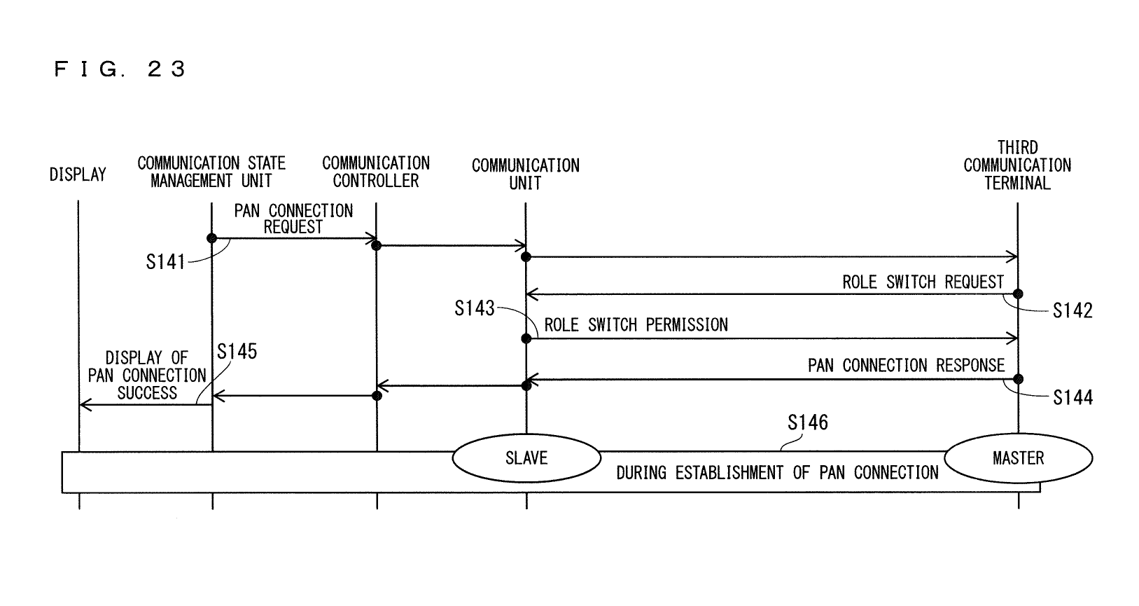

FIGS. 23, 24, 25, and 26 are sequence diagrams illustrating the operation of the on-board device 1 according to the seventh embodiment. Description will be given assuming that a profile connection request is a PAN connection request in the examples of FIGS. 23 to 26, which is not limited thereto.

In the example of FIG. 23, in the communication connection of the third communication terminal 2c, there is no communication terminal 2 being in communication connection with the communication unit 11. In such a case, the process proceeds from Step S22 to Step S24 of FIG. 22, and as illustrated in FIG. 23, Steps S141 to S146 similar to Steps S71 to S76 (FIG. 10) are performed.

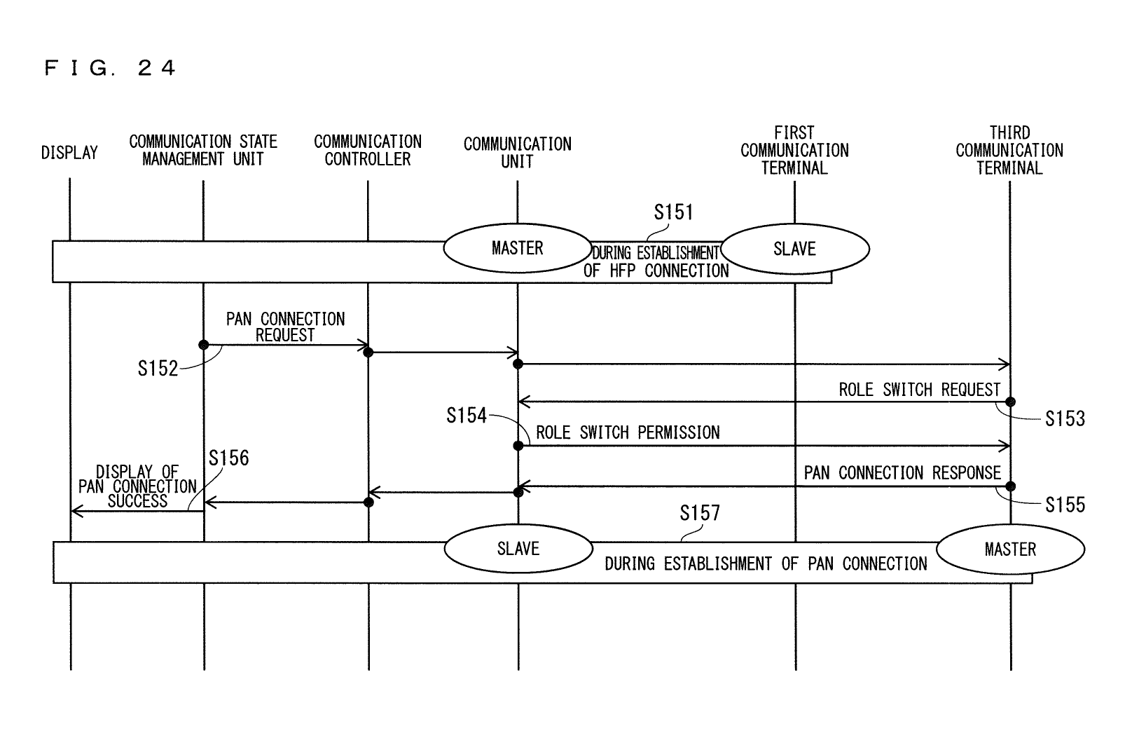

In the example of FIG. 24, in Step S151, an HFP connection in which the communication unit 11 is a master and the first communication terminal 2a is a slave is established between the communication unit 11 and the first communication terminal 2a. In communication connection of the third communication terminal 2c, thus, the communication terminal 2 communicating with the communication unit 11 using a profile is only the first communication terminal 2a. In such a case, the process proceeds from Step S22 to Step S24 of FIG. 22, and as illustrated in FIG. 24, Steps S152 to S157 similar to Steps S71 to S76 (FIG. 10) are performed.

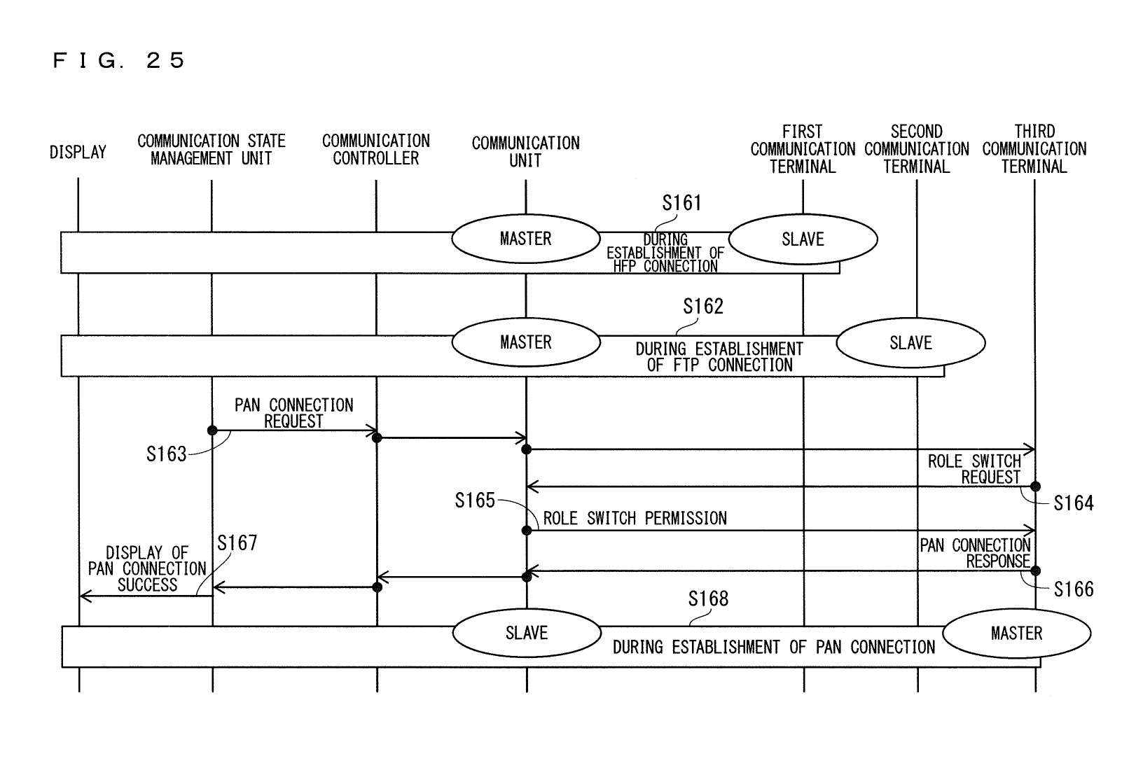

In the example of FIG. 25, in Step S161, an HFP connection in which the communication unit 11 is a master and the first communication terminal 2a is a slave is established between the communication unit 11 and the first communication terminal 2a. In Step S162, an FTP connection in which the communication unit 11 is a master and the second communication terminal 2b is a slave is established between the communication unit 11 and the second communication terminal 2b. When none of the HFP and AVP is used in this manner, the process proceeds from Step S22 to Step S23 of FIG. 22 and then proceeds from Step S23 to Step S24 of FIG. 22, and as illustrated in FIG. 25, Steps S163 to S168 similar to Steps S71 to S76 (FIG. 10) are performed.

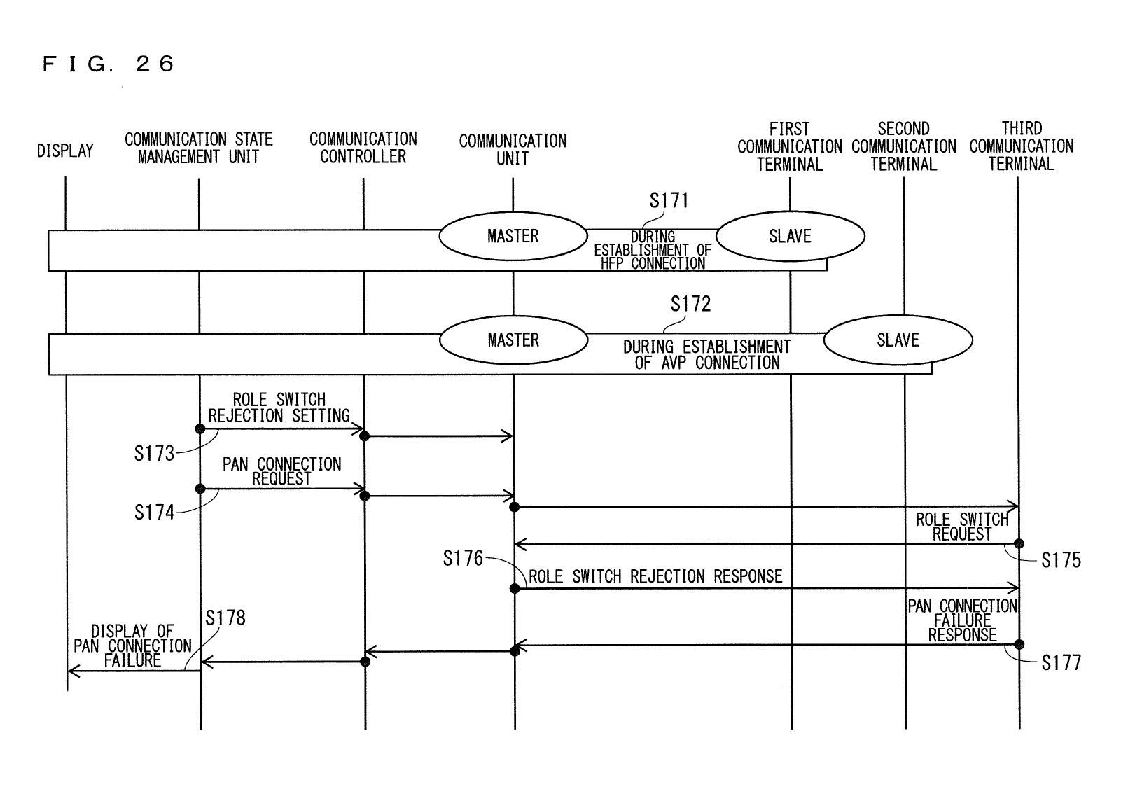

In the example of FIG. 26, in Step S171, an HFP connection in which the communication unit 11 is a master and the first communication terminal 2a is a slave is established between the communication unit 11 and the first communication terminal 2a. Also, in Step S172, an AVP connection in which the communication unit 11 is a master and the second communication terminal 2b is a slave is established between the communication unit 11 and the second communication terminal 2b. In such a case, the process proceeds from Step S22 to Step S23 of FIG. 22 and then proceeds from Step S23 to Step S25 of FIG. 22, and as illustrated in FIG. 26, Steps S173 to S178 similar to Steps S81 to S86 (FIG. 11) are performed.

<Effects>

The on-board device 1 according to the seventh embodiment as described above inhibits a switch of the role of the communication unit 11 from a master to a slave when the communication unit 11 communicates with a plurality of communication terminals 2 using both of the HFP and AVP. This eliminates or reduces collisions of communication operations between different piconets, thus enabling appropriate communication with the communication terminal 2 that assumes only the role of a master while avoiding a conventional problem, that is, a disconnection of AVP communication in a scatternet connection.

### Modification of Seventh Embodiment

The second to sixth embodiments applied to the first embodiment are also similarly applicable to the seventh embodiment.

For example, similarly to the controller 16 according to the second embodiment, the controller 16 according to the seventh embodiment can change, based on profiles used in individual communications between the communication unit 11 and a plurality of communication terminals 2, the types of packets to be assigned to the individual communications. In this case, effects similar to those of the second embodiment are achieved.

Similarly to the controller 16 according to the fifth embodiment, for example, when the role of the communication unit 11 for the first communication terminal 2a is switched to a slave in the communication between the communication unit 11 and the second communication terminal 2b, the controller 16 according to the seventh embodiment can return the role of the communication unit 11 for the first communication terminal 2a to a master in the disconnection of the communication between the communication unit 11 and the second communication terminal 2b. In this case, effects similar to those of the fifth embodiment are achieved.

<Other Modifications>

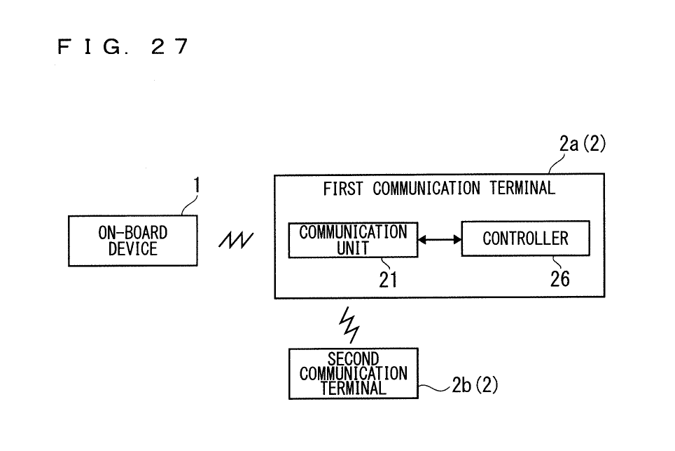

FIG. 27 is a block diagram illustrating a main configuration of a first communication terminal 2a according to a modification. The first communication terminal 2a according to this modification may include a communication unit 21 and a controller 26 similar to the communication unit 11 and the controller 16 described above. In other words, the wireless communication system according to the present invention may be implemented in the first communication terminal 2a. Such a configuration also achieves effects similar to those of the second embodiment. Similarly, though not illustrated in the figure, the wireless communication system according to the present invention may also be implemented in a communication terminal 2 other than the first communication terminal 2a.

The wireless communication system described above is also applicable to a wireless communication system built as a system of an appropriate combination of, for example, an on-board device, a car navigation device, and a portable navigation device (PND) that can be mounted on a vehicle, and a server. In this case, the individual functions or the individual constituent elements of the on-board device 1 described above are dispersedly arranged in the devices constructing the above-mentioned system.

In the present invention, the embodiments and the modifications can be arbitrarily combined, or each preferred embodiment and each modification can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 on-board device, 2 communication terminal, 2a first communication terminal, 2b second communication terminal, 2c third communication terminal, 11 and 21 communication units, 15 display, 16 and 26 controllers.

1. A wireless communication apparatus comprising:
a transceiver to communicate with a communication terminal using a plurality of profiles including a first profile related to hands free calling and a second profile related to audio; and
a controller to inhibit a switch of a role of said transceiver from a master to a slave when no extended synchronization packet is included in packet information transmitted to said transceiver from said communication terminal communicating with said transceiver.

2. The wireless communication apparatus according to claim 1, wherein said controller changes, based on said profiles used in individual communications of said transceiver with a plurality of said communication terminals, types of packets to be assigned to said individual communications.

3. The wireless communication apparatus according to claim 1, wherein when said role of said transceiver for a first communication terminal of a plurality of said communication terminals is switched to a slave in communication between said transceiver and a second communication terminal of said plurality of communication terminals, said controller returns said role of said transceiver for said first communication terminal to a master in disconnection of the communication between said transceiver and said second communication terminal.

4. The wireless communication apparatus according to claim 1, wherein when said transceiver assumes a role of a master for a first communication terminal of a plurality of said communication terminals to form a first piconet and said transceiver assumes a role of a slave for a second communication terminal of said plurality of communication terminals to form a second piconet, said controller sets an offset value of a synchronization clock of said second piconet in said first piconet.

5. The wireless communication apparatus according to claim 1, wherein when said transceiver assumes a role of a slave for a first communication terminal of a plurality of said communication terminals to form a first piconet and said transceiver assumes a role of a slave for a second communication terminal of said plurality of communication terminals to form a second piconet, said controller sets an offset value of a synchronization clock of one of said first piconet and said second piconet in the other.

6. The wireless communication apparatus according to claim 2, wherein when said transceiver assumes a role of a master for a first communication terminal of said plurality of communication terminals to form a first piconet and said transceiver assumes a role of a slave for a second communication terminal of said plurality of communication terminals to form a second piconet, said controller sets an offset value of a synchronization clock of said second piconet in said first piconet.

7. The wireless communication apparatus according to claim 2, wherein when said transceiver assumes a role of a slave for a first communication terminal of said plurality of communication terminals to form a first piconet and said transceiver assumes a role of a slave for a second communication terminal of said plurality of communication terminals to form a second piconet, said controller sets an offset value of a synchronization clock of one of said first piconet and said second piconet in the other.

8. The wireless communication apparatus according to claim 1, further comprising
a display to display said roles of said wireless communication apparatus and roles of said plurality of communication terminals, and said profiles and types of packets used in communications between said wireless communication apparatus and said plurality of communication terminals.

9. A wireless communication apparatus comprising:
a transceiver to communicate with a communication terminal using a plurality of profiles including a first profile related to hands free calling and a second profile related to audio; and
a controller to inhibit a switch of a role of said transceiver from a master to a slave when said transceiver communicates with a plurality of said communication terminals using both of said first and second profiles.

10. The wireless communication apparatus according to claim 9, wherein said controller changes, based on said profiles used in individual communications of said transceiver with a plurality of said communication terminals, types of packets to be assigned to said individual communications.

11. The wireless communication apparatus according to claim 9, wherein when said role of said transceiver for a first communication terminal of a plurality of said communication terminals is switched to a slave in communication between said transceiver and a second communication terminal of said plurality of communication terminals, said controller returns said role of said transceiver for said first communication terminal to a master in disconnection of the communication between said transceiver and said second communication terminal.

12. A communication method for wireless communication, said method comprising:
causing a transceiver to communicate with a communication terminal using a plurality of profiles including a first profile related to hands free calling and a second profile related to audio; and
inhibiting a switch of a role of said transceiver from a master to a slave when no extended synchronization packet is included in packet information transmitted to said transceiver from said communication terminal communicating with said transceiver.
